(19) United States
(12) Patent Application Publication
(10) Pub. No.: US 2009/0268822 A1
(43) Pub. Date: Oct. 29, 2009

(54) MOTION VECTOR DETECTION BY STEPWISE SEARCH

(76) Inventors: Kengo TERADA, Osaka (JP); Kouji Nakajima, kyoto (JP); Keisuke Kondou, Osaka (JP)

Correspondence Address: MCDERMOTT WILL & EMERY LLP, 600 13TH STREET, NW, WASHINGTON, DC, 20005-3096, US

(21) Appl. No.: 12/273,717

(22) Filed: Nov. 19, 2008

(30) Foreign Application Priority Data
Apr. 24, 2008 (JP) 2008-114380

(51) Int. Cl. H04N 11/02; G06K 9/36; H04N 7/12

(52) U.S. Cl. 375/240.16; 382/236; 375/E07.1; 375/E07.113; 375/E07.105

(57) ABSTRACT

A moving image encoding apparatus includes a motion vector detecting unit for executing from a wide and coarse search to a narrow and fine search in a plurality of steps and in a stepwise manner to detect a motion vector of each block in an input image. The motion vector detecting unit includes a block combining unit for generating a combination block, depending on a result of detection in a search step, a search use pixel extracting unit for extracting a search use pixel to be used in a next search step, from the combination block, and a second search combination block searching unit for performing the next search step with respect to the combination block using the search use pixel, and setting a detected motion vector of the combination block as the motion vector of each block of the combination block.

### BACKGROUND OF THE INVENTION

1. Field of the Invention

The present invention relates to an apparatus and method for encoding a moving image frame, and more particularly, to a technique of detecting a motion vector.

2. Description of the Related Art

In recent years, technology of digital video apparatuses has significantly advanced, so that a video signal (a plurality of moving image frames arranged in time series) input via a camcorder or a television tuner is increasingly often compression-encoded and recorded into a recording medium, such as a DVD, a hard disk or the like. When the video signal is encoded, motion compensation is often used so as to reduce the amount of codes. Motion compensation refers to a technique of predicting a current moving image frame (current image) from at least either the previous or next moving image frame (reference image) and encoding a difference between the current moving image and the predicted image. In order to predict a current image, a motion vector detecting process is performed so as to find motion information (motion vector).

However, the motion vector detecting process generally requires a large process amount, and therefore, there is a demand for a reduction in the process amount in view of power consumption of an LSI, real-time image recording, or the like. Therefore, a technique of detecting a motion vector by executing from a wide and coarse search to a narrow and fine search in a plurality of steps, i.e., in a stepwise manner, has been disclosed (see Japanese Unexamined Patent Application Publication No. H11-122618).

### SUMMARY OF THE INVENTION

Conventionally, the process amount of motion vector detection is reduced by a stepwise search. However, both the wide and coarse search and the narrow and fine search are performed with respect to all blocks on a block-by-block basis, so that the process amount is still large.

A moving image encoding apparatus according to an aspect of the present invention is an apparatus for sequentially encoding a plurality of moving image frames, including a motion vector detecting unit for executing from a wide and coarse search to a narrow and fine search in a plurality of steps and in a stepwise manner to detect a motion vector of each block in an input image. The motion vector detecting unit includes a block combining unit for generating a combination block, depending on a result of detection in a search step, a search use pixel extracting unit for extracting a search use pixel to be used in a next search step, from the combination block, and a combination block searching unit for performing the next search step with respect to the combination block using the search use pixel, and setting a detected motion vector of the combination block as the motion vector of each block of the combination block.

### BRIEF DESCRIPTION OF THE DRAWINGS

FIG. 1 is a block diagram showing a whole configuration of a moving image encoding apparatus according to a first embodiment of the present invention.

FIG. 2 is a block diagram showing an internal configuration of a motion vector detecting unit of Embodiment 1.

FIG. 3A is a diagram for describing search points in a first search of Embodiment 1.

FIG. 3B is a diagram for describing search points in a second search of Embodiment 1.

FIG. 4 is a diagram showing a relationship between a process time combination parameter and each combination parameter of Embodiment 1.

FIG. 5A is a diagram showing an example of search use pixel extraction of Embodiment 1, where the size of a combination block is two blocks.

FIG. 5B is a diagram showing an example of search use pixel extraction of Embodiment 1, where the size of a combination block is three blocks.

FIG. 6 is a diagram showing a relationship between a process time and a process time combination parameter of Embodiment 1.

FIG. 7 is a flowchart for describing an operation of the motion vector detecting unit of Embodiment 1.

FIG. 8 is a block diagram showing an internal configuration of a motion vector detecting unit according to Embodiment 2.

FIG. 9 is a diagram showing an example of search use pixel extraction of Embodiment 2.

FIG. 10 is a flowchart for describing an operation of the motion vector detecting unit of Embodiment 2.

FIG. 11 is a block diagram showing a whole configuration of an image recording apparatus according to Embodiment 3.

FIG. 12 is a block diagram showing an internal configuration of a motion vector detecting unit of Embodiment 3.

FIG. 13 is a diagram showing a relationship between a shooting mode, an image size, and a mode combination parameter of Embodiment 3.

FIG. 14 is a diagram showing a relationship between a process time combination parameter, a mode combination parameter, and each combination parameter of Embodiment 3.

### DETAILED DESCRIPTION OF THE PREFERRED EMBODIMENTS

Hereinafter, embodiments of a moving image encoding apparatus and the like will be described with reference to the accompanying drawings. Note that components having the same reference numerals perform similar operations in the embodiments and will not be described again in some cases.

### Embodiment 1

<Whole Configuration>

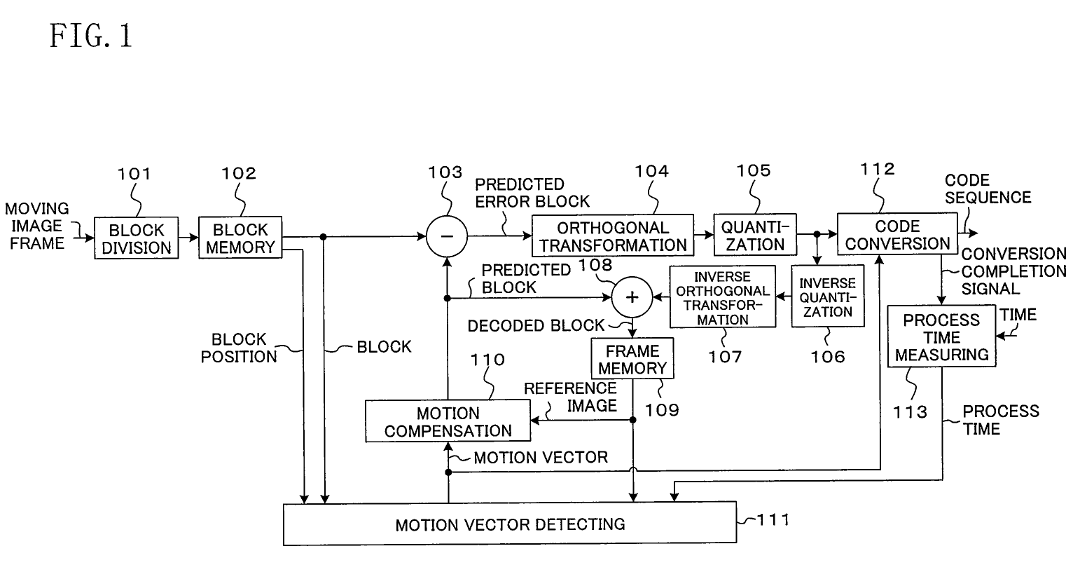

FIG. 1 shows a whole configuration of a moving image encoding apparatus according to a first embodiment of the present invention. The moving image encoding apparatus, which is an apparatus for sequentially encoding a plurality of moving image frames that are arranged in time series using a motion vector, detects the motion vector by a two-step search including a first search having a low accuracy (coarse) and a second search having a high accuracy (fine). The moving image encoding apparatus comprises a block division unit 101, a block memory 102, a subtraction unit 103, an orthogonal transformation unit 104, a quantization unit 105, an inverse quantization unit 106, an inverse orthogonal transformation unit 107, an addition unit 108, a frame memory 109, a motion compensation unit 110, a motion vector detecting unit 111, a code conversion unit 112, and a process time measuring unit 113.

The block division unit 101 divides an input moving image frame into blocks having a predetermined size. The block division unit 101 also sequentially outputs the division blocks, and sequentially outputs block positions that indicate positions where the respective blocks are located in the moving image frame. The block memory 102 stores the blocks and their block positions. The subtraction unit 103 calculates a difference between a block stored in the block memory 102 and a predicted block from the motion compensation unit 110, and outputs the difference as a predicted error block to the orthogonal transformation unit 104. The orthogonal transformation unit 104 converts the predicted error block into frequency components by orthogonal transformation, and outputs the orthogonal-transformed block to the quantization unit 105. The quantization unit 105 quantizes the orthogonal-transformed block, and outputs the quantized block to the code conversion unit 112 and the inverse quantization unit 106.

The inverse quantization unit 106 inverse-quantizes the quantized block, and outputs the inverse-quantized block to the inverse orthogonal transformation unit 107. The inverse orthogonal transformation unit 107 performs inverse orthogonal transformation with respect to the inverse-quantized block, and outputs the inverse-orthogonal-transformed block to the addition unit 108. The addition unit 108 generates a decoded block by adding the inverse-orthogonal-transformed block and the predicted block output by the motion compensation unit 110, and stores the decoded block into the frame memory 109. The frame memory 109 stores a plurality of decoded blocks, which constitute a reference image.

The motion vector detecting unit 111 uses the blocks, the block positions, the reference image, and a process time to output motion vectors of the blocks. The motion compensation unit 110 generates predicted blocks from the reference image using the motion vectors. The code conversion unit 112 performs variable-length or fixed-length encoding with respect to the quantized blocks and the motion vectors, and outputs a code sequence. The code conversion unit 112 outputs a conversion completion signal to the process time measuring unit 113 every time one block is completely encoded.

The process time measuring unit 113 receives conversion completion signals from the code conversion unit 112, calculates a process time of motion vector detection from times when the conversion completion signals are received, and outputs the process time to the motion vector detecting unit 111. For example, if it is assumed that a time when the conversion completion signal of a block j is received is 100 ms and a time when the conversion completion signal of a block j+1 is received is 140 ms, it takes 40 ms to encode the block j+1. In the case of a system in which thirty moving image frames need to be encoded per second, one moving image frame needs to be encoded in an average of 33 ms, and therefore, the encoding process time needs to be reduced. In this case, the process time measuring unit 113 sets the process time to be within 15 ms and outputs the process time to the motion vector detecting unit 111 even if the process time measuring unit 113 normally sets the process time to be within 20 ms.

### <Internal Configuration of Motion Vector Detecting Unit>

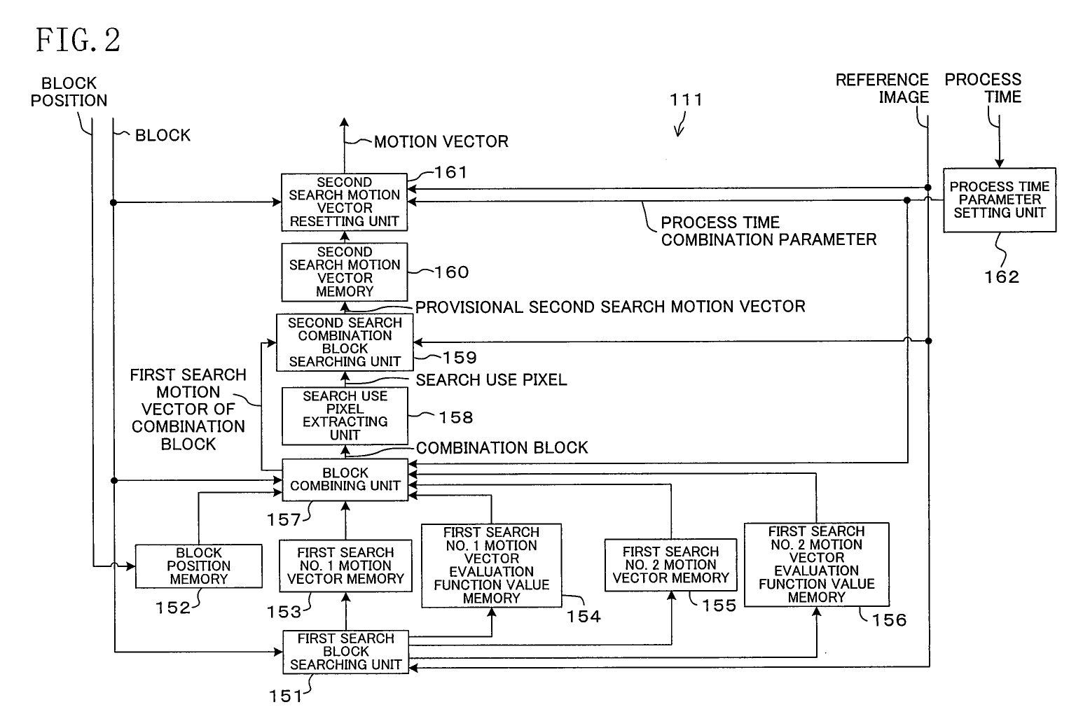

FIG. 2 shows an internal configuration of the motion vector detecting unit 111 of FIG. 1. The motion vector detecting unit 111 comprises a first search block searching unit 151, a block position memory 152, a first search No. 1 motion vector memory 153, a first search No. 1 motion vector evaluation function value memory 154, a first search No. 2 motion vector memory 155, a first search No. 2 motion vector evaluation function value memory 156, a block combining unit 157, a search use pixel extracting unit 158, a second search combined block searching unit 159, a second search motion vector memory 160, a second search motion vector resetting unit 161, and a process time parameter setting unit 162.

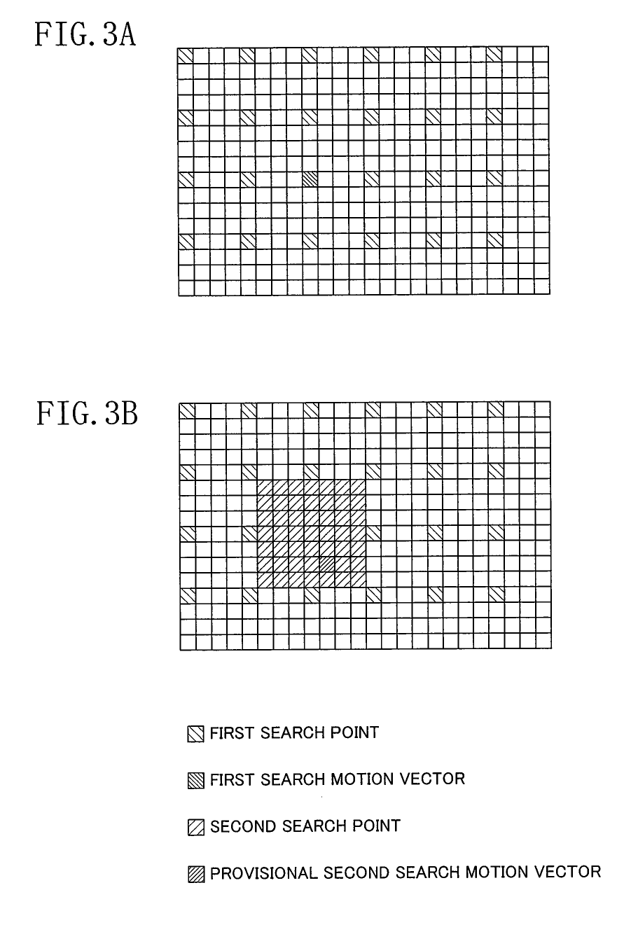

The first search block searching unit 151 performs a low-accuracy block matching search between a reference image and blocks, stores a position having a smallest evaluation function value as a first search No. 1 motion vector into the first search No. 1 motion vector memory 153, and stores its evaluation function value into the first search No. 1 motion vector evaluation function value memory 154. The first search block searching unit 151 also stores a position having a second smallest evaluation function value as a first search No. 2 motion vector into the first search No. 2 motion vector memory 155, and stores its evaluation function value into the first search No. 2 motion vector evaluation function value memory 156. Here, as an evaluation function value, the sum of the absolute values of differences between pixels of the reference image and pixels of a block is used. Also, in the block matching search of the first search block searching unit 151, in order to coarsely search the reference image, the search is performed every four pixels in the reference image as shown in FIG. 3A.

The block combining unit 157 combines blocks using the first search No. 1 motion vectors, the first search No. 1 motion vector evaluation function values, the first search No. 2 motion vectors, the first search No. 2 motion vector evaluation function values, the block positions, and a process time combination parameter. Specifically, a block A and a block B are combined when any one of the following sets of conditions 1 to 4 is satisfied.

1. The difference between the first search No. 1 motion vector (A) and the first search No. 1 motion vector (B) is smaller than or equal to an approximation α,

the first search No. 1 motion vector evaluation function value (A) is smaller than or equal to an evaluation value β,

the first search No. 1 motion vector evaluation function value (B) is smaller than or equal to the evaluation value β,

the number of combination determination vectors is one or more, and the difference between A and B is lower than or equal to a distance γ.

2. The difference between the first search No. 1 motion vector (A) and the first search No. 2 motion vector (B) is smaller than or equal to the approximation α,

the first search No. 1 motion vector evaluation function value (A) is smaller than or equal to the evaluation value β,

the first search No. 2 motion vector evaluation function value (B) is smaller than or equal to the evaluation value β,

the number of combination determination vectors is two or more, and

the difference between A and B is lower than or equal to the distance γ.

3. The difference between the first search No. 2 motion vector (A) and the first search No. 1 motion vector (B) is smaller than or equal to the approximation α,

the first search No. 2 motion vector evaluation function value (A) is smaller than or equal to the evaluation value β,

the first search No. 1 motion vector evaluation function value (B) is smaller than or equal to the evaluation value β,

the number of combination determination vectors is two or more, and

the difference between A and B is lower than or equal to the distance γ.

4. The difference between the first search No. 2 motion vector (A) and the first search No. 2 motion vector (B) is smaller than or equal to the approximation α,

the first search No. 2 motion vector evaluation function value (A) is smaller than or equal to the evaluation value β,

the first search No. 2 motion vector evaluation function value (B) is smaller than or equal to the evaluation value β,

the number of combination determination vectors is two or more, and

the difference between A and B is lower than or equal to the distance γ.

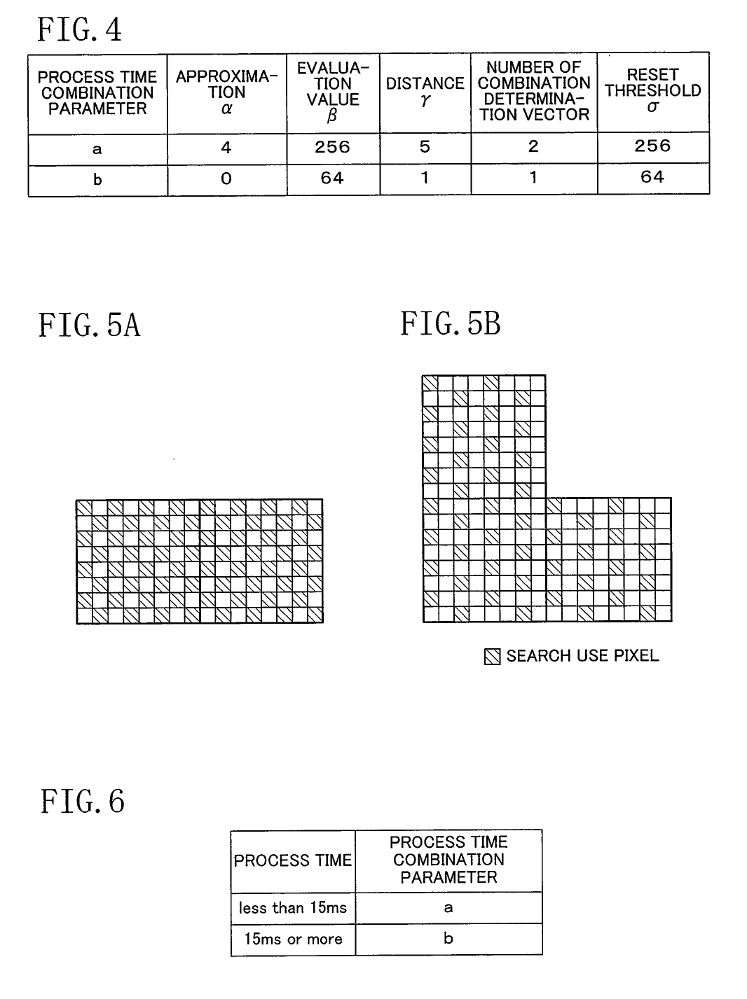

The approximation α, the evaluation value β, the distance γ, and the number of combination determination vectors are determined using the process time combination parameter from the process time parameter setting unit 162 as shown in FIG. 4. For example, if the process time combination parameter is b, then when the difference between the first search No. 1 motion vector (A) and the first search No. 1 motion vector (B) is 0 (i.e., the first search No. 1 motion vector (A) and the first search No. 1 motion vector (B) are the same), the first search No. 1 motion vector evaluation function value (A) and the first search No. 1 motion vector evaluation function value (B) are both 64 or less, and the distance between A and B is 1 or less (i.e., A and B are adjacent to each other), the block A and the block B are to be combined. Conversely, when the process time combination parameter is a, condition for combination are more relaxed than when it is b, so that block combination is more frequently performed than when it is b.

Also, the block combining unit 157 outputs an average of the first search motion vectors (motion vectors meeting combination conditions) of blocks in a combination block, as a first search motion vector of the combination block, to the second search combined block searching unit 159. For example, when the difference between the first search No. 1 motion vector (A) and the first search No. 2 motion vector (B) is lower than or equal to the approximation α, and therefore, a combination block of the block A and the block B is generated, an average of the first search No. 1 motion vector of the block A and the first search No. 2 motion vector of the block B is defined as a first search motion vector of the combination block. Note that a block that is not combined with any block is output singly as a combination block to the search use pixel extracting unit 158.

The search use pixel extracting unit 158 extracts, from a combination block, a reduced number of search use pixels that are to be used in the second search combined block searching unit 159 (i.e., thins the search use pixels). How much the search use pixels are thinned is changed, depending on the size of the combination block. As the size of the combination block increases, the search use pixels are more largely thinned. FIGS. 5A and 5B show search use pixels, where one block is composed of 8 pixels×8 pixels. In FIG. 5A, a combination block has a size of two blocks. In FIG. 5B, a combination block has a size of three blocks.

The second search combined block searching unit 159 performs a high-accuracy block matching search between a reference image and a combination block, where the position of the first search motion vector of the combination block is a center, and stores a position having a smallest evaluation function value, as a provisional second search motion vector for all blocks in the combination block, to the second search motion vector memory 160. As an evaluation function value, the sum of the absolute values of differences between pixels of the reference image and pixels of the combination block is used, and only search use pixels are used for calculation of the evaluation function value. Also, the block matching search of the second search combined block searching unit 159 is performed without skipping a pixel as shown in FIG. 3B, so as to finely search the reference image.

The second search motion vector resetting unit 161 calculates an evaluation function value using the provisional second search motion vector, the reference image, and a block, and when the evaluation function value is larger than or equal to a reset threshold σ, performs a high-accuracy block matching search between the reference image and the block, and outputs a position having a smallest evaluation function value as a motion vector of the block. In this case, the evaluation function value is calculated using pixels in the block in addition to search use pixels. On the other hand, when the evaluation function value is smaller than the reset threshold σ, the provisional second search motion vector as it is, is output as a motion vector. The reset threshold σ is set using the process time combination parameter from the process time parameter setting unit 162 as shown in FIG. 4.

The process time parameter setting unit 162 sets the process time combination parameter using a process time as shown in FIG. 6, and outputs the process time combination parameter to the block combining unit 157 and the second search motion vector resetting unit 161.

<Operation>

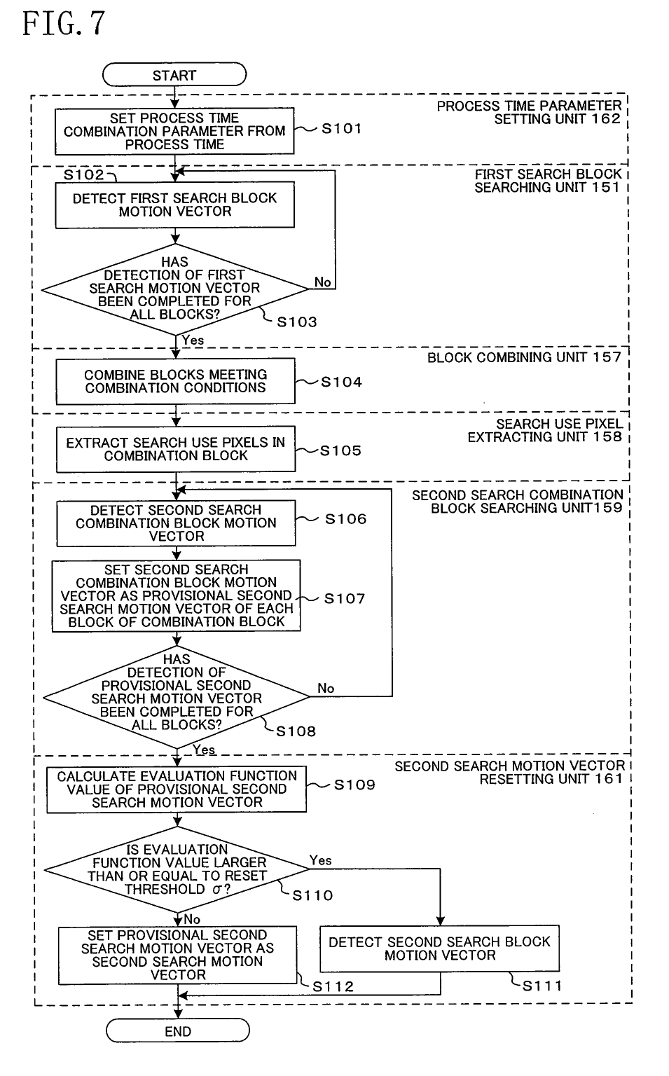

Next, a motion vector detecting process by the motion vector detecting unit 111 of FIG. 2 will be described with reference to FIG. 7.

Step S101: Initially, the process time parameter setting unit 162 is used to set a process time combination parameter from a process time, and output the process time combination parameter to the block combining unit 157 and the second search motion vector resetting unit 161. Next, the process goes to step S102.

Step S102: The first search block searching unit 151 is used to detect a first search motion vector of a block. Next, the process goes to step S103.

Step S103: It is determined whether or not a first search motion vector has been detected for all blocks in a moving image frame. When the result of determination is positive, the process goes to step S104, and when the result of determination is negative, the process returns to step S102.

Step S104: The block combining unit 157 is used to combine blocks using the first search No. 1 motion vectors, the first search No. 1 motion vector evaluation function values, the first search No. 2 motion vectors, the first search No. 2 motion vector evaluation function values, the block positions, and the process time combination parameter. Next, the process goes to step S105.

Step S105: The search use pixel extracting unit 158 is used to extract, from the combination block, search use pixels that are to be used in the second search combined block searching unit 159. Next, the process goes to step S106.

Step S106: The second search combined block searching unit 159 is used to detect a motion vector of the combination block. Next, the process goes to step S107.

Step S107: The detected combination block motion vector is set as a provisional second search motion vector for each block in the combination block. Next, the process goes to step S108.

Step S108: It is determined whether or not a provisional second search motion vector has been set for all blocks in the moving image frame. When the result of determination is positive, the process goes to step S109, and when the result of determination is negative, the process returns to step S106.

Step S109: The second search motion vector resetting unit 161 is used to calculate an evaluation function value using the provisional second search motion vector, the reference image, and the block. Next, the process goes to step S110.

Step S110: When the evaluation function value calculated in step S109 is larger than or equal to the reset threshold σ, the process goes to step S111, and when the evaluation function value is smaller than the reset threshold σ, the process goes to step S112. The reset threshold σ is determined using the process time combination parameter from the process time parameter setting unit 162.

Step S111: A high-accuracy block matching search is performed between the reference image and the block. A position having a smallest evaluation function value is output as a motion vector of the block.

Step S112: The provisional second search motion vector as it is, is output as a motion vector.

<Effect>

As described above, according to this embodiment, only search use pixels are used for calculation of an evaluation function value in the second search, so that the process amount of motion vector detection can be reduced.

Also, when motion vectors of blocks are encoded in the code conversion unit 112, a difference between motion vectors of adjacent blocks is encoded. When adjacent blocks are combined, the adjacent blocks have the same motion vector, so that the amount of motion vector codes can be reduced.

Also, if adjacent blocks have different motion vectors, a phenomenon called block noise that a block border causes a decoded video image to be unnatural, is likely to occur. However, when adjacent blocks are combined, the adjacent blocks have the same motion vector, so that block noise can be reduced.

Also, when the number of pixels used for calculation of an evaluation function value is reduced, a motion vector having a smaller predicted error can be detected if blocks having the same motion are combined to enlarge the block size of block matching. Since blocks having close motion vectors that are obtained by the first search are highly likely to be of objects having the same motion, a motion vector having a smaller predicted error can be detected by combining the blocks.

Also, only blocks having evaluation function values obtained by the first search that are within a specific range may be combined. Therefore, when the probability of an increase in predicted error is high, blocks are not combined, so that an increase in predicted error is prevented. When the probability of an increase in predicted error is low, blocks are combined, so that the process amount of motion vector detection can be reduced. Specifically, the probability of an increase in predicted error is low when the evaluation function value obtained by the first search is small or extremely large. The evaluation function value obtained by the first search is small when a motion of a block can be correctly detected by the first search. In this case, blocks having the same motion vector are highly likely to have the same motion vector obtained by the second search. Therefore, if the blocks are combined, the probability of an increase in predicted error is low. Also, when the evaluation function value obtained by the first search is extremely large, the evaluation function value obtained by the second search is highly likely to be large even if blocks are not combined, so that the probability of an increase in predicted error due to block combination is low.

Also, blocks having a large distance therebetween may not be combined. In this case, blocks that are highly likely not to have the same motion are not combined, so that an increase in predicted error due to block combination can be suppressed.

Also, combination may be determined using a plurality of motion vectors having a small evaluation function value. Thereby, the probability of block combination is increased. Therefore, the process amount can be largely reduced. In addition, since motion vectors having a small evaluation function value are used, an increase in predicted error can be suppressed.

Also, the second search motion vector resetting unit 161 may be provided so as to combine blocks. In this case, when a predicted error will become large, blocks are not combined. Thereby, an increase in predicted error can be suppressed.

Also, the combination parameter may be set, depending on the process time. When there is a margin of process time, an increase in predicted error is suppressed by causing block combination to be more difficult. When the process time is tight, the process amount can be significantly reduced by causing block combination to be easier.

Although the two-step search including the first search and the second search is performed in this embodiment, a three or more-step search may be performed.

Also, in the case of the three or more-step search, the second search may be performed in units of a combination block as in this embodiment, and the third search and thereafter or only the final search may be performed in units of a block.

Also, it has been assumed above that the extraction of a search use pixel is changed, depending on the size of a combination block. Alternatively, instead of changing, a search use pixel may be invariably extracted every a constant number of pixels. Also, instead of thinning pixels, an image feature, such as an edge pixel of an image or the like, may be used to extract a search use pixel.

Also, although it has been assumed above that block combination is performed using a motion vector of the first search, an evaluation function value of the motion vector, and a block position, only the motion vector of the first search may be employed.

Also, although it has been assumed above that two motion vectors, i.e., the first search No. 1 motion vector and the first search No. 2 motion vector, are used, the present invention is not limited to this. Only one motion vector may be used, or three or more motion vectors may be used. When only one motion vector is used, the first search No. 2 motion vector memory 155 and the first search No. 2 motion vector evaluation function value memory 156 are not required.

Also, although it has been assumed above that combination is performed if the evaluation function value of a motion vector of the first search is smaller than or equal to the evaluation value β, combination may be performed if the evaluation function value is within a specific range or is larger than or equal to a specific threshold.

Also, although it has been assumed above that a second search motion vector is reset in the second search motion vector resetting unit 161, the present invention is not limited to this. A provisional second search motion vector may be invariably output as a motion vector from the motion vector detecting unit 111 without providing the second search motion vector resetting unit 161.

Also, although it has been assumed above that the process time parameter setting unit 162 is used to change the process time combination parameter, motion vector detection may be performed with a constant process time combination parameter without providing the process time parameter setting unit 162.

Moreover, the process of this embodiment may be implemented by software. The software may be distributed by downloading or the like. Alternatively, the software may be recorded in a recording medium, such as a CD-ROM or the like, which is in turn distributed. Note that the same is true of other embodiments described herein.

### Embodiment 2

<Whole Configuration>

A moving image encoding apparatus according to a second embodiment of the present invention has a configuration similar to that of FIG. 1, except for the internal configuration of the motion vector detecting unit 111.

<Internal Configuration of Motion Vector Detecting Unit>

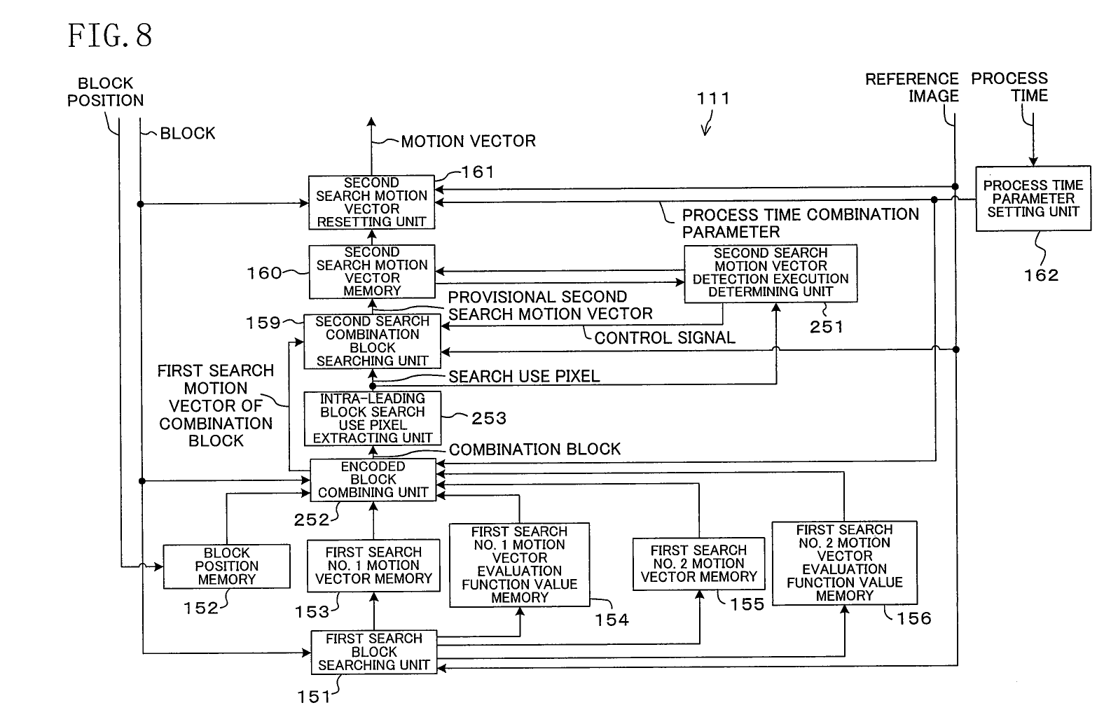

FIG. 8 shows an internal configuration of the motion vector detecting unit 111 in this embodiment. The motion vector detecting unit 111 includes a second search motion detection execution determining unit 251 in addition to the configuration of FIG. 2. The motion vector detecting unit 111 also includes an encoded block combining unit 252 instead of the block combining unit 157 of FIG. 2, and an intra-leading block search use pixel extracting unit 253 instead of the search use pixel extracting unit 158. The other configuration is similar to that of FIG. 2.

The encoded block combining unit 252 performs block combination using only encoded blocks or only blocks that are being encoded, in a moving image frame.

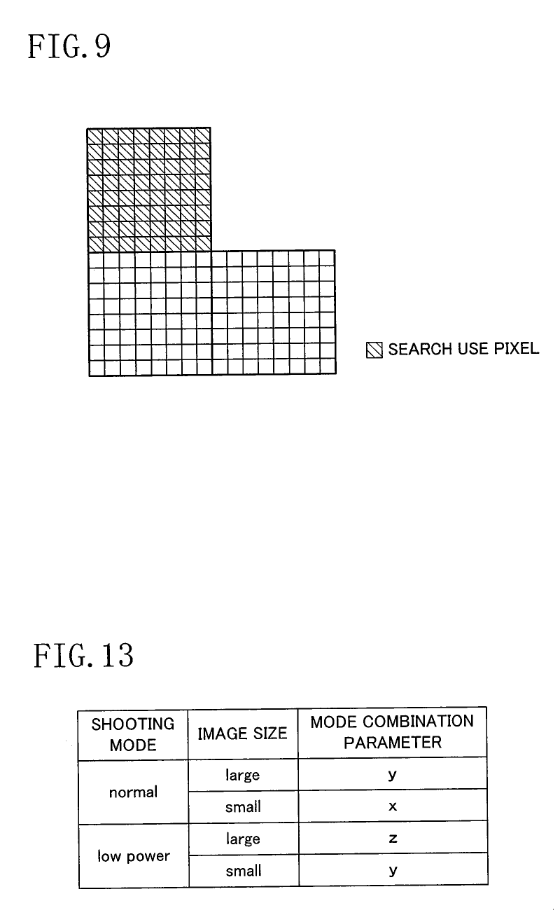

The intra-leading block search use pixel extracting unit 253 extracts search use pixels to be used in the second search combined block searching unit 159, from a block that is the first block in order of encoding in the combination block. FIG. 9 shows search use pixels when encoding is performed from a block at an upper left end to the right in a moving image frame, where each block is composed of 8 pixels×8 pixels and the size of a combination block is three blocks. Search use pixels are extracted only from the upper left block that is the first one in order of encoding.

The second search motion detection execution determining unit 251 receives a search use pixel and determines whether or not the second search has been performed using the same search use pixel, and if the result of determination is negative, uses a control signal to instruct the second search combined block searching unit 159 to activate, so that the second search combined block searching unit 159 detects a provisional second search motion vector using the search use pixel as in Embodiment 1. On the other hand, if the result of determination is positive, the second search motion detection execution determining unit 251 uses a control signal to instruct the second search combined block searching unit 159 to stop, and stores a previously detected provisional second search motion vector, as a provisional second search motion vector for each block in a combination block, to the second search motion vector memory 160.

<Operation>

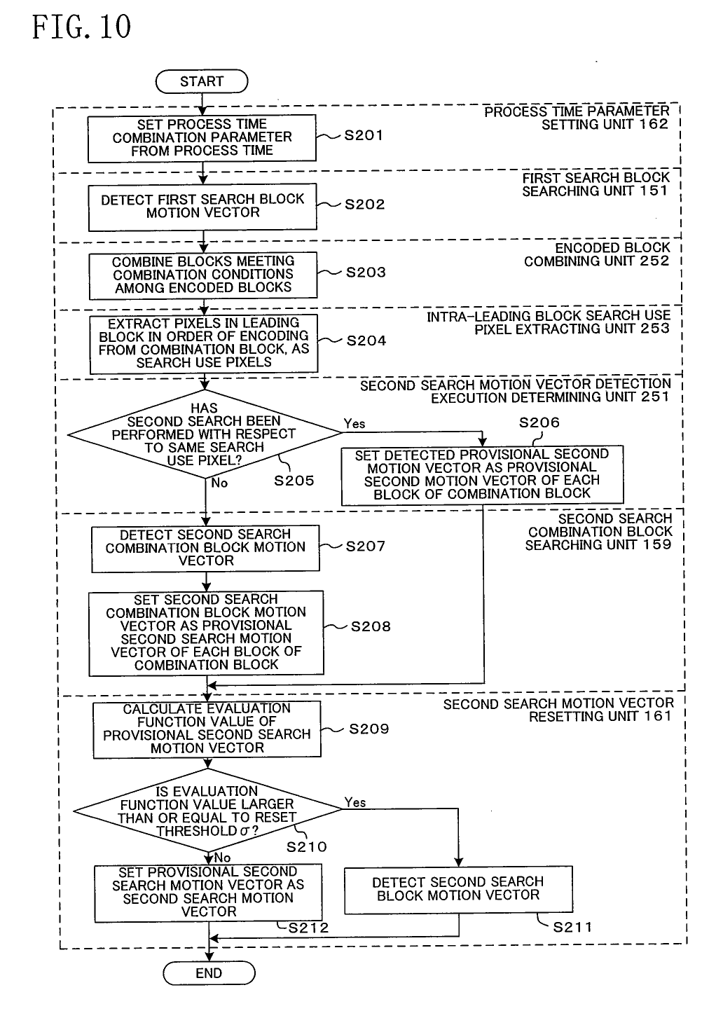

Next, a motion vector detecting process performed by the motion vector detecting unit 111 of FIG. 8 will be described with respect to FIG. 10.

Step S201: Initially, the process time parameter setting unit 162 is used to set a process time combination parameter from a process time, and output the process time combination parameter to the encoded block combining unit 252 and the second search motion vector resetting unit 161. Next, the process goes to step S202.

Step S202: The first search block searching unit 151 is used to detect a first search motion vector of a block. Next, the process goes to step S203.

Step S203: The encoded block combining unit 252 is used to combine only encoded blocks or blocks that are being encoded in a moving image frame. Next, the process goes to step S204.

Step S204: The intra-leading block search use pixel extracting unit 253 is used to extract search use pixels to be used in the second search combined block searching unit 159, from a block that is the first block in order of encoding in a combination block. Next, the process goes to step S205.

Step S205: The second search motion detection execution determining unit 251 is used to determine whether or not the second search has been performed using the same search use pixel. If the result of determination is positive, the process goes to step S206, and if otherwise, the process goes to step S207.

Step S206: A previously detected provisional second search motion vector is stored, as a provisional second search motion vector of each block in the combination block, to the second search motion vector memory 160. The process goes to step S209 without performing the second search.

Step S207: The second search combined block searching unit 159 is used to detect a motion vector of the combination block. Next, the process goes to step S208.

Step S208: The detected combination block motion vector is set as a provisional second search motion vector of each block in the combination block. Next, the process goes to step S209.

Step S209: The second search motion vector resetting unit 161 is used to calculate an evaluation function value using the provisional second search motion vector, the reference image, and the block. Next, the process goes to step S210.

Step S210: When the evaluation function value calculated in step S209 is larger than or equal to a reset threshold a, the process goes to step S211, and when the evaluation function value is smaller than the reset threshold a, the process goes to step S212. The reset threshold a is set using the process time combination parameter from the process time parameter setting unit 162.

Step S211: A high-accuracy block matching search is performed using the reference image and the block, and a position having a smallest evaluation function value is output as a motion vector of the block.

Step S212: The provisional second search motion vector as it is, is output as a motion vector.

<Effect>

As described above, according to this embodiment, motion vectors of blocks can be detected in order of encoding, and the number of times of transfer of a block and a reference image from the block memory 102 and the frame memory 109 to the motion vector detecting unit 111 can be caused to be one per encoding of one block, so that the rate of data transfer can be increased.

### Embodiment 3

<Whole Configuration>

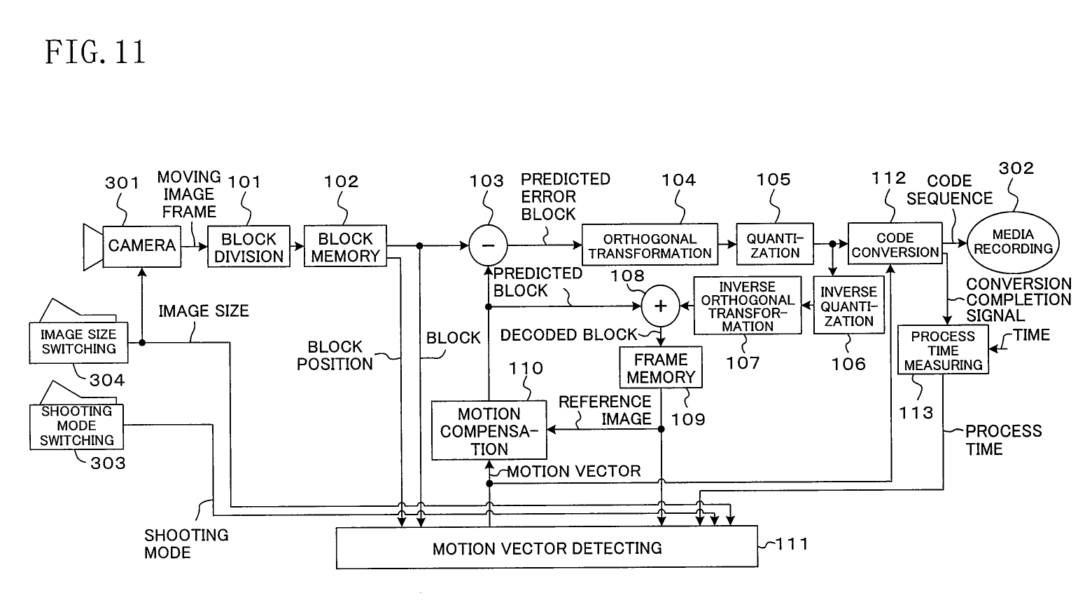

FIG. 11 shows a configuration of an image recording apparatus according to a third embodiment of the present invention. The image recording apparatus comprises a camera unit 301, a media recording unit 302, a shooting mode switching unit 303, and an image size switching unit 304 in addition to the configuration of FIG. 1.

The shooting mode switching unit 303 outputs a shooting mode designated by the user to the motion vector detecting unit 111. There are two shooting modes, i.e., a low power mode and a normal mode. When the user desires to shoot for a long time using a battery, the user designates the low power mode. The image size switching unit 304 outputs an image size designated by the user to the camera unit 301 and the motion vector detecting unit 111.

The camera unit 301 takes video corresponding to an image size from the image size switching unit 304, and outputs a moving image frame to the block division unit 101. The media recording unit 302 records a code sequence from the code conversion unit 112 into a recording medium, such as a CD, a DVD, a Bluray-Disc, an SD card, a hard disk or the like.

<Internal Configuration of Motion Vector Detecting Unit>

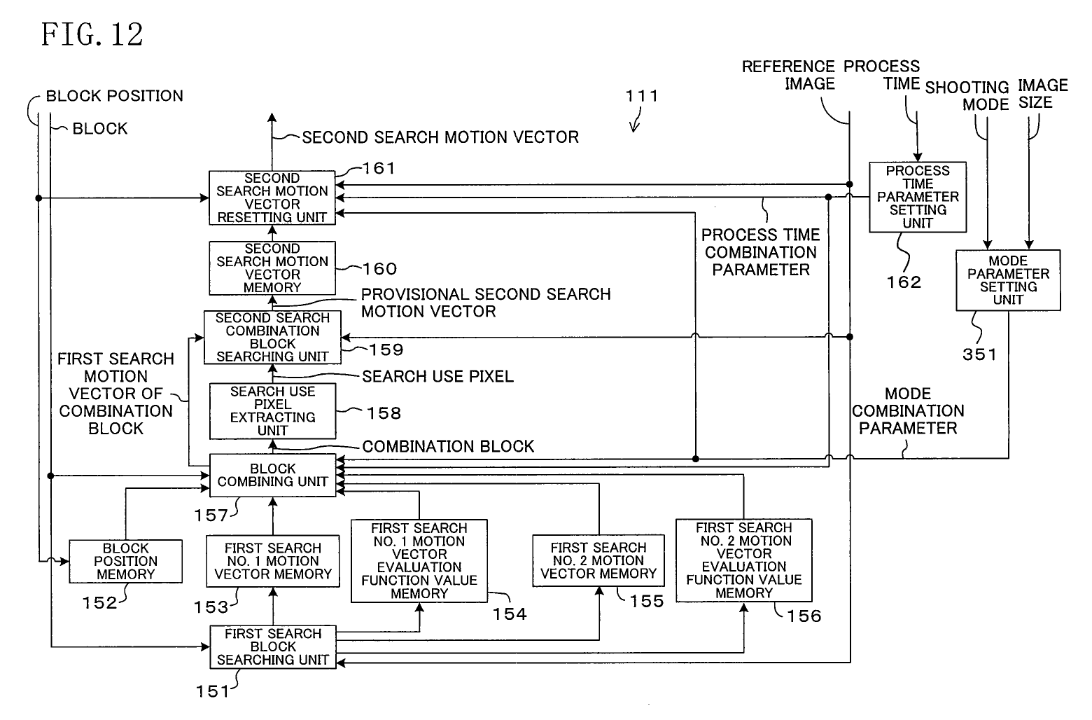

FIG. 12 shows an internal configuration of the motion vector detecting unit 111 of this embodiment. The motion vector detecting unit 111 includes a mode parameter setting unit 351 in addition to the configuration of FIG. 2.

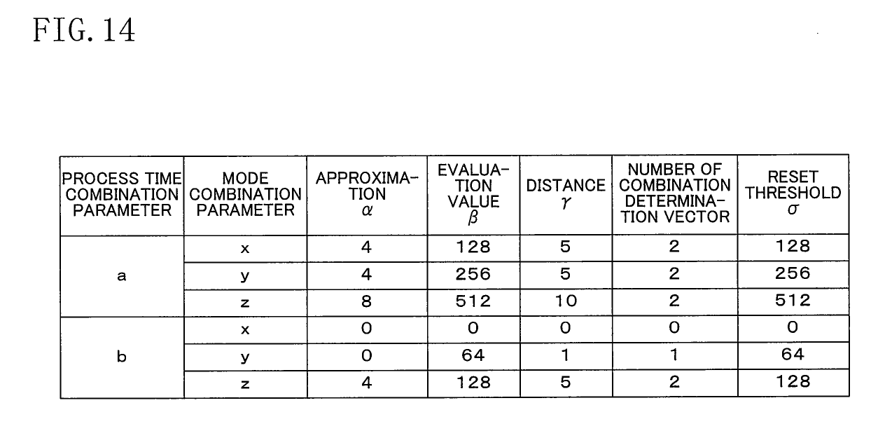

The mode parameter setting unit 351 sets mode combination parameters based on a shooting mode and an image size as shown in FIG. 13, and outputs the mode combination parameters to the block combining unit 157 and the second search motion vector resetting unit 161. Also, the combination parameters, i.e., the approximation α, the evaluation value β, the distance γ, the number of combination determination vectors, and the reset threshold σ are set using the process time combination parameter and the mode combination parameter as shown in FIG. 14. Note that the process time combination parameter is set from a process time as in Embodiment 2. When there is a large process amount limitation, i.e., the shooting mode is set to be the low power mode or the image size is large, a larger number of blocks are combined, and resetting of a motion vector by the second search motion vector resetting unit 161 is caused not to be performed, thereby setting the combination parameters so that the process amount of motion vector detection is significantly reduced. Also, when there is a small process amount limitation, i.e., the shooting mode is set to be the normal mode or the image size is small, the conditions for block combination are caused to be strict, thereby suppressing an increase in predicted error due to block combination. When there is an extremely small process amount limitation, e.g., the process time combination parameter is b (the process time is 15 ms or more) and the mode combination parameter is x (the shooting mode is the normal mode and the image size is small), the combination parameters are set so that block combination is not performed.

<Effect>

As described above, according to this embodiment, a video signal can be recorded with a small process amount. Also, by changing the parameters based on the shooting mode and the image size as appropriate, the process amount can be largely reduced when there is a large process amount limitation, and the image quality or the compression ratio can be maintained high when there is a small process amount limitation.

Although it has been assumed above that the image size switching unit 304 and the shooting mode switching unit 303 are provided, only either of them may be provided.

Also, although it has been assumed above that the image size switching unit 304 switches two image sizes (small and large image sizes), the present invention is not limited to this. The image size switching unit 304 may switch three or more image sizes.

Also, although it has been assumed above that the shooting mode switching unit 303 switches two modes (the low power mode and the normal mode), the present invention is not limited to this. The shooting mode switching unit 303 may switch three or more modes, such as a high image quality mode and the like.

Also, although a camcorder has been described as an example in this embodiment, the present invention can also be applied to a mobile telephone with camera, an accumulation/reproduction apparatus (e.g., a DVD recorder, etc.), and the like.

In each of the above-described embodiments, each functional block can be typically implemented by an MPU, a memory or the like. Moreover, the process of each functional block may be typically implemented by software (a program). The software is recorded in a recording medium, such as a ROM or the like. The software may be distributed by downloading or the like. Alternatively, the software may be recorded in a recording medium, such as a CD-ROM or the like, which is in turn distributed. Note that each functional block can also be implemented by hardware (a dedicated circuit).

Also, the process that has been described in each embodiment may be achieved by a centralized process using a single apparatus (system). Alternatively, the process may be achieved by a distributed process using a plurality of apparatuses. A single or a plurality of computers may be used to execute the program. In other words, either a centralized process or a distributed process may be performed.

As described above, the moving image encoding apparatus according to the present invention can encode a moving image frame with a small process amount, and therefore, is useful for a camcorder, a mobile telephone with camera, a DVD recorder and the like.

Note that the present invention is not limited to the embodiment described above, and various modifications can be made without departing from the scope of the present invention.

What is claimed is:

1. A moving image encoding apparatus for sequentially encoding a plurality of moving image frames, comprising:
a motion vector detecting unit for executing from a wide and coarse search to a narrow and fine search in a plurality of steps and in a stepwise manner to detect a motion vector of each block in an input image,
wherein the motion vector detecting unit includes:
a block combining unit for generating a combination block, depending on a result of detection in a search step;
a search use pixel extracting unit for extracting a search use pixel to be used in a next search step, from the combination block; and
a combination block searching unit for performing the next search step with respect to the combination block using the search use pixel, and setting a detected motion vector of the combination block as the motion vector of each block of the combination block.

2. The moving image encoding apparatus of claim 1, wherein
the block combining unit generates, as a combination block, a group of blocks for which a difference in motion vector as the result of detection of the search step is smaller than or equal to an approximation threshold.

3. The moving image encoding apparatus of claim 1, wherein
the block combining unit generates, as a combination block, a group of blocks for which a difference in motion vector as the result of detection of the search step is smaller than or equal to an approximation threshold and an evaluation function value of the motion vector of the search step is within an effective evaluation value range.

4. The moving image encoding apparatus of claim 1, wherein
the block combining unit generates, as a combination block, a group of blocks for which a difference in motion vector as the result of detection of the search step is smaller than or equal to an approximation threshold and a distance between each block is smaller than or equal to a distance threshold.

5. The moving image encoding apparatus of claim 1, wherein
the block combining unit obtains motion vectors in descending order of evaluation function value in a search step, the number of motion vectors being equal to the number of combination determination vectors, and generates, as a combination block, a group of blocks for which a difference of any of the motion vectors is smaller than or equal to an approximation threshold.

6. The moving image encoding apparatus of claim 1, further comprising:
a motion vector resetting unit for calculating an evaluation function value of a block using a motion vector detected by the combination block searching unit in the next search step, and when the evaluation function value is smaller than or equal to a reset threshold, executing the next search step in units of a block to reset the motion vector of the next search step.

7. The moving image encoding apparatus of claim 1, wherein
the search use pixel extracting unit extracts, as a search use pixel, a pixel of a block that is the first of the combination block in order of encoding.

8. The moving image encoding apparatus of claim 1, further comprising:
a process time parameter setting unit for receiving a process time of motion vector detection, and based on the process time, setting an approximation threshold, an effective evaluation value range, a distance threshold, the number of combination determination vectors, and a reset threshold.

9. A moving image encoding method for sequentially encoding a plurality of moving image frames, comprising:
a motion vector detecting step of executing from a wide and coarse search to a narrow and fine search in a plurality of steps and in a stepwise manner to detect a motion vector of each block in an input image,
wherein the motion vector detecting step includes:
generating a combination block, depending on a result of detection in a search step;
extracting a search use pixel to be used in a next search step, from the combination block; and
performing the next search step with respect to the combination block using the search use pixel, and setting a detected motion vector of the combination block as the motion vector of each block of the combination block.

10. An image recording apparatus comprising:
a moving image encoding apparatus for sequentially encoding a plurality of moving image frames;
an image input unit for inputting a plurality of moving image frames to the moving image encoding apparatus; and
a media recording unit for recording a code sequence generated using a motion vector from the moving image encoding apparatus into a recording medium,
wherein the moving image encoding apparatus includes a motion vector detecting unit for executing from a wide and coarse search to a narrow and fine search in a plurality of steps and in a stepwise manner to detect a motion vector of each block in an input image, and
the motion vector detecting unit includes:
a block combining unit for generating a combination block, depending on a result of detection in a search step;
a search use pixel extracting unit for extracting a search use pixel to be used in a next search step, from the combination block; and
a combination block searching unit for performing the next search step with respect to the combination block using the search use pixel, and setting a detected motion vector of the combination block as the motion vector of each block of the combination block.

11. The image recording apparatus of claim 10, wherein
the moving image encoding apparatus further includes a mode parameter setting unit for receiving at least any of an image size of a moving image frame and an operation mode for changing an encoding process time, and based on the at least any of the image size of the moving image frame and the operation mode for changing the encoding process time, setting an approximation threshold, an effective evaluation value range, a distance threshold, the number of combination determination vectors, and a reset threshold, and
the image recording apparatus further includes at least any of an image size setting unit for setting the image size or an operation mode setting unit for setting the operation mode.

12. An image recording apparatus comprising:
a moving image encoding apparatus for sequentially encoding a plurality of moving image frames;
an image input unit for inputting a plurality of moving image frames to the moving image encoding apparatus; and
a media recording unit for recording a code sequence generated using a motion vector from the moving image encoding apparatus into a recording medium,
wherein the moving image encoding apparatus sets the same motion vector for regions that are determined by a coarse-accuracy search to have the same motion.

13. The image recording apparatus of claim 12, wherein
the moving image encoding apparatus has a function of receiving at least any of an image size of a moving image frame and an operation mode for changing an encoding process time, and in the case of an operation mode in which the image size is large or the encoding process time is small, setting the same motion vector, and
the image recording apparatus further includes at least any of an image size setting unit for designating the image size and an operation mode setting unit for designating the operation mode.
